(19) United States
(12) Patent Application Publication
(10) Pub. No.: US 2022/0198542 A1
(43) Pub. Date: Jun. 23, 2022

(54) CLOTHING RECOMMENDATION USING A NUMERIC ESTIMATION MODEL

(71) Applicant: Micron Technology, Inc., Boise, ID (US)

(72) Inventors: Yifen Liu, Boise, ID (US); Linh H. Nguyen, Boise, ID (US); Libo Wang, Boise, ID (US); Ariela E. Gruszka, Boise, ID (US); Carla L. Christensen, Golden Valley, ID (US)

(21) Appl. No.: 17/398,641

(22) Filed: Aug. 10, 2021

Related U.S. Application Data
(60) Provisional application No. 63/127,019, filed on Dec. 17, 2020.

(51) Int. Cl. G06Q 30/06; G06N 20/00

(52) U.S. Cl. CPC G06Q 30/0631; G06Q 30/0641; G06N 20/00

(57) ABSTRACT

Methods and non-transitory machine-readable media associated with clothing recommendations are described. Clothing recommendations can include identifying, using a model built based on input data previously received in association with an article of clothing associated with a child, physical data associated with the child, and image data of the child with a reference object, output data representative of a clothing size recommendation for the child and sending, in response to a user request or a data refresh, the clothing size recommendation, a different article of clothing recommendation for the child based at least in part on the output data, or both, to a user device.

### PRIORITY INFORMATION

This application is a Non-Provisional Application of U.S. Provisional Application 63/127,019, filed Dec. 17, 2020, the contents of which are herein incorporated by reference.

### TECHNICAL FIELD

The present disclosure relates generally to apparatuses, non-transitory machine-readable media, and methods associated with identifying and determining a clothing recommendation.

### BACKGROUND

Memory resources are typically provided as internal, semiconductor, integrated circuits in computers or other electronic systems. There are many different types of memory, including volatile and non-volatile memory. Volatile memory can require power to maintain its data (e.g., host data, error data, etc.). Volatile memory can include random access memory (RAM), dynamic random-access memory (DRAM), static random-access memory (SRAM), synchronous dynamic random-access memory (SDRAM), and thyristor random access memory (TRAM), among other types. Non-volatile memory can provide persistent data by retaining stored data when not powered. Non-volatile memory can include NAND flash memory, NOR flash memory, and resistance variable memory, such as phase change random access memory (PCRAM) and resistive random-access memory (RRAM), ferroelectric random-access memory (FeRAM), and magnetoresistive random access memory (MRAM), such as spin torque transfer random access memory (STT RAM), among other types.

Electronic systems often include a number of processing resources (e.g., one or more processing resources), which may retrieve instructions from a suitable location and execute the instructions and/or store results of the executed instructions to a suitable location (e.g., the memory resources). A processing resource can include a number of functional units such as arithmetic logic unit (ALU) circuitry, floating point unit (FPU) circuitry, and a combinatorial logic block, for example, which can be used to execute instructions by performing logical operations such as AND, OR, NOT, NAND, NOR, and XOR, and invert (e.g., NOT) logical operations on data (e.g., one or more operands). For example, functional unit circuitry may be used to perform arithmetic operations such as addition, subtraction, multiplication, and division on operands via a number of operations.

Artificial intelligence (AI) can be used in conjunction with memory resources. AI can include a controller, computing device, or other system to perform a task that normally requires human intelligence. AI can include the use of one or more machine learning models. As described herein, the term “machine learning” refers to a process by which a computing device is able to improve its own performance through iterations by continuously incorporating new data into an existing statistical model. Machine learning can facilitate automatic learning for computing devices without human intervention or assistance and adjust actions accordingly.

### BRIEF DESCRIPTION OF THE DRAWINGS

FIG. 1 is a flow diagram representing an example method for making a clothing recommendation in accordance with a number of embodiments of the present disclosure.

FIG. 2 is another flow diagram representing an example method for making a clothing recommendation in accordance with a number of embodiments of the present disclosure.

FIG. 3 is a functional diagram representing a processing resource in communication with a memory resource having instructions written thereon in accordance with a number of embodiments of the present disclosure.

FIG. 4 is another functional diagram representing a processing resource in communication with a memory resource having instructions written thereon in accordance with a number of embodiments of the present disclosure.

FIG. 5 is yet another flow diagram representing an example method for making a clothing recommendation in accordance with a number of embodiments of the present disclosure.

### DETAILED DESCRIPTION

Apparatuses, machine-readable media, and methods related to making a clothing recommendation are described. Different children grow at different rates, and children's clothing brands and styles may vary in sizes, styles, and/or fit. This can result in poor-fitting clothing, wasted clothing, money lost on un-returned items, etc. As used herein, “clothing” and “article(s) of clothing” can include an item or items worn to cover the body, including, but not limited to, a shirt, a dress, pants, shorts, a hat, accessories, shoes, etc.

Examples of the present disclosure can allow for a determination of a child's clothing size and/or physical measurements using a numeric estimation model and/or a machine learning model (e.g., AI). For instance, using image data stored with a cloud service or on a user device (e.g., a smart phone), along with other physical data associated with the child (e.g., height, weight, neck size, head circumference, etc.), a numeric estimation model can be built and used to estimate measurements and a clothing size of a child. A recommendation of a particular article of clothing may also be made, in some examples.

Examples of the present disclosure can include identifying, using a model built based on input data previously received in association with an article of clothing associated with a child, physical data associated with the child, and image data of the child with a reference object, output data representative of a clothing size recommendation for the child, and sending, in response to a user request or a data refresh, the clothing size recommendation, a different article of clothing recommendation for the child based at least in part on the output data, or both, to a user device.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context.

The figures herein follow a numbering convention in which the first digit or digits correspond to the figure number and the remaining digits identify an element or component in the figure. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

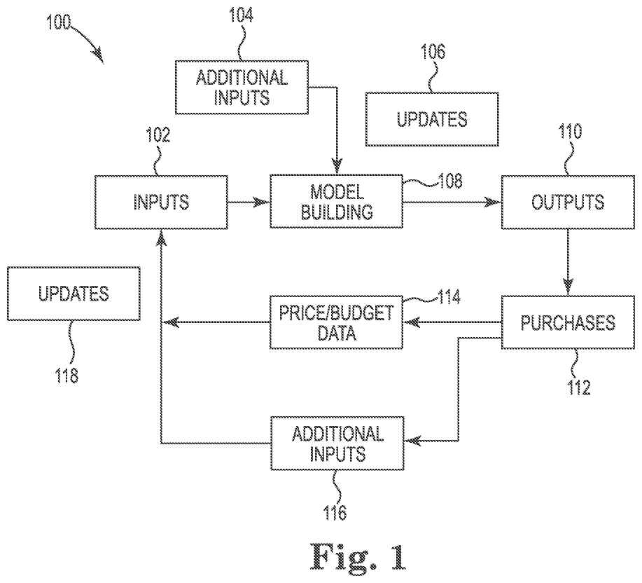

FIG. 1 is a flow diagram representing an example method 100 for making a clothing recommendation in accordance with a number of embodiments of the present disclosure. At 102, inputs can be received, for instance via an application of a user device or website, at a model building tool that is part of the model building at 108. The inputs may come from a user device or a cloud storage service, among others. The inputs can include image data such as images stored in a memory resource of the user device (e.g., a camera roll of a smartphone, photos saved on a personal computer, etc.) and image data retrieved from the cloud storage service (e.g., “the cloud”). In some examples, inputs can include growth charts from clinical visits, which may be obtained from a health source such as a physician's office health care provider database or added by a user of the user device (e.g., manual input). Other inputs may include a private calendar stored on the user device or in a cloud storage service, public calendars, social media images, images with the child or other children and a reference object (e.g., a chair, a basketball, an oven, etc.), among others. Additional inputs may be received at 104 and used for model building at 108, as will be discussed further herein.

The model building tool can include, in some examples, a processing resource in communication with a memory resource that utilizes a numeric estimation model, AI, or both, to make a clothing recommendation (e.g., size, particular article of clothing, etc.) for a child. Put another way, the model building tool can determine a current size, future size, or both, for a child, recommend the size or sizes, and recommend a particular article of clothing based on data available to the model building tool including, but not limited to, the inputs received at 102. The model building tool can facilitate communication between sources (e.g., devices, retailers, cloud service providers, etc.). For instance, the sources may not communicate directly with one another, but may share data with the model building tool, which can in turn, communicate that shared data with other sources, where applicable. In some examples, the sources may communicate with one another.

The model building tool (and associated numeric estimation models and AI (e.g., including machine learning model(s)) can be trained using a training dataset. For instance, the training dataset can include a set of examples used to fit parameters of the AI. For instance, the training dataset can include data associated with children's clothing sizes and associated measurements, children's clothing brands, seasons and associated weather, geographic location, holidays and associated dates, children's clothing costs, etc. In some examples, the model building tool can also be trained using new input data (e.g., new data from user, retailers, reviewers, physicians, etc., among others).

As noted, the model building tool can receive input data from a plurality of sources. The input data can be encrypted, in some examples. Sources can include, for example, image storage on a user (e.g., mobile) device associated with the child such as a parent's smartphone, a portion of a memory resource or other storage, a health care provider database, a third-party retailer database, a calendar on the mobile device, environmental data, third-party websites, or any combination thereof In some examples, input data can be received from a source or sources via an application on a user device and associated with the model building tool. The model building tool, in some examples, can update as image data is added to and received by a cloud storage service or user device storage. For instance, the model building tool may “run in the background” such that as image data is added to associated storage, model building tool can be updated.

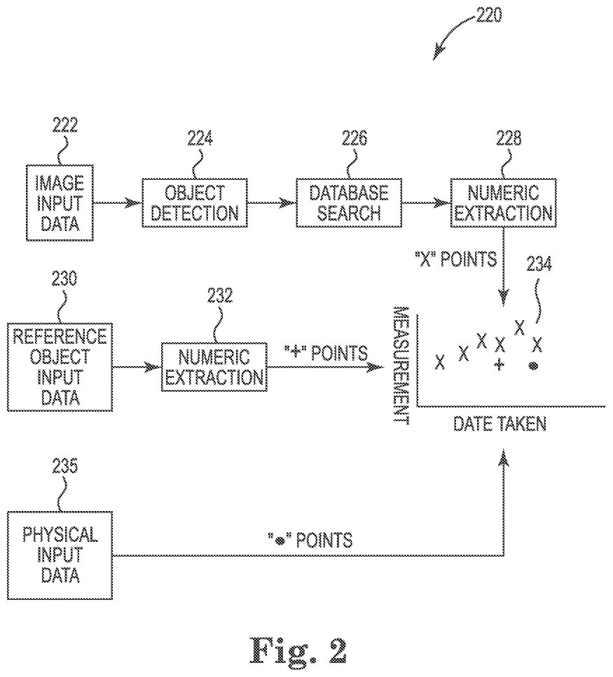

The model building tool can extract numeric data from the different inputs received at 102 and 104 and can build a numeric estimation model at 108. The numeric data, for instance, can include physical measurements and/or sizes based on the input data. As will be discussed further herein with respect to FIG. 2, object detection, database searches, reference object models, and/or growth charts, among others, can be used to extract numeric data from different inputs. Using the numeric data, the numeric estimation model can be built. The numeric estimation model can include, for instance, a model that considers different weighted data points to build a proposed growth chart and can include a least root mean square model or other numeric estimation model, as will be discussed further herein with respect to FIG. 2. In some instances, the numeric estimation model can include a machine learning model and can self-learn to update as additional input is received.

The model building tool can identify data representative of a clothing size recommendation for the child, a particular article of clothing recommendation for the child, or both, based at least in part on the numeric estimation model. The numeric estimation model considers the input data received at 102, 104, or both, which may be representative of image data, physical data, budget data, weather data, calendar data, and manually input data, among others, or any combination thereof.

The model building tool can output a recommendation at 110 based on the numeric estimation model. The recommendation can include, for instance, estimated measurements of the child, a recommendation of a current clothing size (e.g., shoe size, shirt size, pant size, etc.) of a child, a future clothing size (e.g., in 3 months, in 6 months, in 1 year, etc.), and/or a recommendation for a particular article of clothing (e.g., a shirt that fits now, a shirt that fits in 3 months, boots that fit in 6 months, etc.). If inputs received at 102 or 104 include calendar input data, a recommendation may include clothing associated with a current or upcoming season or an upcoming holiday or event, for instance. For instance, if the recommendation is made in early October, a recommendation may include a Halloween costume estimated to fit the child well immediately or a holiday outfit estimated to fit the child well in 2 months based on the numeric estimation model.

Based on the outputs (e.g., recommendations) at 110, a user may make a purchase at 112. A purchase may be facilitated via a retail website or application in some examples. For instance, if output data at 110 includes a recommendation of a particular article of clothing (e.g., a particular pair of winter boots), the user may choose to purchase those boots or different footwear. In some examples, the user may be automatically provided with an opportunity to purchase the recommended clothing. Price and/or budget data and other additional inputs may be determined at 114 and 116, respectively, and those updates can be added to update, refine, or both, at 118, to the inputs received at 102 and used in the model building tool and recommendations.

For example, price information from articles of clothing purchased by the user, for instance via a retail website or application, can be gathered and/or received at 114 and used as additional inputs to update, refine, or both, a size or clothing recommendation of the machine learning model. Similar, manually entered budget data (e.g., entered via an application on a user device) or budget data determined based on purchase history can be gathered and/or received at 114 and those updates can be received (e.g., at 118) and used at 102 as additional inputs to update, refine, or both, a size or clothing recommendation. Additional input, for instance gathered and/or received at 116, can include new image data from a retail website and/or application with known clothing dimensions (e.g., known dimensions and associated sizes of shoes, tops, pants, etc.). Other additional input may include updated size estimations based on a comparison to previous estimations/projections and whether a customer returned an article of clothing, among others. Such additional updates can be received (e.g., at 118) and used as input at 102. In some examples, inputs received at 102, 104, 114, and 116 can include associated confidence weights and/or can be used to adjust confidence weights of other inputs, as will be discussed further herein with respect to FIG. 2.

In some examples, feedback can be requested regarding the model building tool. A user may be prompted to take a survey or leave feedback regarding ease of use, results, accuracy, visuals, usefulness, and performance of the model building tool (e.g., how well clothing fit, if clothing was returned, costs and quality of clothing, etc.). Based on the received feedback, the model building tool can be adjusted. For instance, based on the feedback, the model building tool may be adjusted to improve a user interface, accessibility, visuals, numeric estimation model used, etc.

In some examples, the model building tool and/or associated AI and memory resource or storage can be updated based on the data associated with the input as discussed herein. For instance, additional inputs can be received at 104, including but not limited to new image data, weather updates, season changes, particular period of time passing and/or calendar updates, among others and the updates can be added, for instance at 106, and become a part of model building at 108. Other additional inputs can include product information from a manufacturer, measurements inferred by a processing resource associated with a camera on a smart device, measurements estimated using sensors associate with a camera on a smart device, clothing sizes and/or styles inferred from social media images or images of children known to a user (e.g., a friend's child), used versus new preferences, purchase timeline preferences (e.g., prefer to buy on sale in off-season), and style preferences (e.g., no onesies, no dresses, etc.), among others. This additional input, in some examples, may be received, at 104, 114, and/or 116.

The additional input data received at 104, 114, and/or 116 can be saved in the memory resource or storage and the model building tool can self-learn to update and improve accuracy and efficiency of clothing recommendations, in some examples. In some instances, as will be discussed further herein with respect to FIG. 2, calibration sources and confidence weights can be considered when updating the model building tool, machine learning model, and/or numeric estimation model.

In a non-limiting example of the present disclosure, a parent of a child can access a clothing recommendation application via his or her smart phone. However, the example provided herein is not limited to the particular devices, recommendations, or input data. The parent may allow the application to access his or her cloud storage service, camera roll, or other source of image data. The user may also manually upload image data to the application. Using the image input data, a model building tool can extract numeric data from the image input data and create a numeric estimation model. The model building tool can also use other input data including reference object input data, physical input data (physician's growth chart, manual measurements, etc.), and/or preference input data (e.g., budget data, style preference data, season preference data, color preference data, etc.).

A machine learning model can extract data from images provided by manufacturers on websites, applications, etc. and extract numeric data such as measurements of neck size, height, weight, armpit size, chest size, etc. of children in the images and/or articles of clothing in the images. The machine learning model can also extract numeric data from the user's input data, along with any additional data (e.g., return versus keep data, color preferences, calendar data, etc.), build a numeric estimation model, and make clothing recommendations based on the different types of data and the numeric estimation model.

In the aforementioned example, the parent may be provided with a recommendation that the child is a size 6 in brands X, Y, and Z, but a size 7 in brand Q. The parent may also be provided with recommendations of a pink or similarly colored coats that should fit the child in 6 months and are within a desired budget, per preference inputs. The parent may be presented with items outside of the budget, for instance, to entice sales, for instance, if the parent is accessing a retail website linked to the application or cloud storage service. In another example, the parent may be presented with holiday dress recommendations when the parent's calendar indicates a child's holiday program occurring in a particular time period. Should the parent choose to make a purchase, the machine learning model can request feedback and use the feedback to improve the model building tool, including the numeric estimation model.

FIG. 2 is another flow diagram representing an example method 220 for making a clothing recommendation in accordance with a number of embodiments of the present disclosure. FIG. 2 illustrates different sources and input data associated with a model building tool. For instance, the model building tool can receive image input data at 222, reference object input data at 230, and physical input data at 235. Image input data can include image data associated with a child stored on a user device (e.g., smart phone, table, personal computer, etc.), with a cloud storage service, or in other storage. Reference object input data can include image data of the child with a reference object of known or likely known size and/or dimensions, for instance a standard basketball, an oven, a doorway, etc. Physical input data can include physical measurements of the child such as height, weight, head circumference, foot length, foot width, chest size, or neck size, among others, that is input manually (e.g., via an application on a user device) or received, with consent, from a health source database (e.g., a family physician's office).

Each type of input data can be assigned a confidence weight. For instance, physical input data received from a physician's office may be weighted higher (e.g., have a higher confidence level) than image input data received from a camera roll of a user device. This is because the physical input data may have a higher precision and be more likely to be accurate than the image input data.

The model building tool may receive input data from a user via an application downloaded on a mobile device, such as a clothing recommendation application acting as an interface for input data. For instance, a user device (e.g., smart phone, personal computer, laptop, tablet, and/or wearable device (e.g., smartwatch)) may provide data to the application or the user may manually input data into the application (e.g., height, weight, growth charts, etc.). In some examples, the input data can be received from a cloud storage service. For instance, image data stored in the cloud storage service may be automatically sent to and received by the model building tool. In such an example, a user may grant the cloud storage service permission to release the image data, for instance via the application on the user device or via a retail website or application. Numeric data can be extracted from the input data received at 222, 230, and 235 and can be used to create a numeric estimation model, as illustrated by the growth chart 234. For instance, a smooth curve fitting model (e.g., a locally weighted linear regression) may be used in conjunction with data points on the growth chart 234 to determine a recommendation, as will be discussed further herein. The growth chart 234 can include, for instance, an x-axis representing a date of an image (e.g., data a photograph was taken) or an age, and a y-axis representing a measurement of the child, such as height as shown in growth chart 234. Other measurements may be part of a growth chart or multiple growth charts may be created based on the different physical measurements determined.

In some examples, image data associated with a child's clothing can be received at 222. For instance, an image that includes a child in a snowsuit may be received at 222 automatically (e.g., with limited or no user prompting) from a cloud storage service, on-device storage, via a camera roll, etc. At 224, object detection can be used to detect the snowsuit in the image. While a snowsuit is used in this example, any article of clothing may be included and detected. In images with more than one article of clothing, each article (e.g., shirt, pants, boots, hat, etc.) may be detected.

At 226, a database search can be performed to find matching articles of clothing, in this example a snowsuit. For instance, different search approaches may be used to search databases of clothing for matches to the detected snowsuit. In some examples, an inquiry for finding a particular article of clothing in the user image may be sent to retailers to allow for a retailer database search or a search in user email accounts to identify purchase history with matching clothing images, among others. Examples used for database searches may include the use of computer vision including calculations and comparisons of image histograms. Other examples may include the use of one-shot learning including using a triplet loss to train a Siamese network, for instance similar to facial recognition with improved accuracy. Other approaches, including machine learning models, may be used to search a database or databases, in some examples.

When an image, or an image within a threshold similarity range, is detected in the database, numeric data including costs, size, dimensions, and text or other image format data can be extracted. For instance, at 228, numeric data can be extracted from the input data, including clothing measurement information from retail websites (e.g., selling same or similar items as detected in the image input data) that can be used as an estimate of the child's size. This extracted numeric data can be added as points (e.g., “X” points) to a personalized growth chart for the child, as illustrated at 234. The extracted numeric data can be used to build a numeric estimation model that considers confidence weights associated with each input, as will be discussed further herein.

At 230, reference object input data, such as an image of the child with a standard size basketball, can be received. At 232, numeric data can be extracted, for instance using a pixel comparison approach where a distance per pixel comparison is made between the child and the reference object to determine an approximate size of the child and corresponding measurements. While a basketball is used in this example, any reference object with a known or likely known size may be included and used for comparison. In images with more than one reference object, each reference object (e.g., basketball, basketball hoop, sportscar, etc.) may be used for comparison.

The extracted numeric data can be added as points (e.g., “+” points) to a personalized growth chart for the child, as illustrated at 234. The extracted numeric data can be used to build a numeric estimation model that considers confidence weights associated with each input, as will be discussed further herein.

At 235, physical input data, such as a child's growth chart from a clinical visit, can be received. While a growth chart is used in this example, any physical measurement, such as a child's height measured by a parent and entered into an application on a smart phone, may be included and used as numeric data. In received data with more than one measurement, each measurement (e.g., height, weight, foot length, head circumference, etc.) may be used for as numeric data. Because the physical input data may already be numeric, it may or may not need to be extracted. The extracted numeric data can be added as points (e.g., “·” points) to a personalized growth chart for the child, as illustrated at 234. The numeric data can be used to build a numeric estimation model that considers confidence weights associated with each input, as will be discussed further herein.

While not illustrated in FIG. 2, additional input data and/or feedback can be used to update and improve accuracy of the numeric estimation model and/or recommendation. For instance, prior purchase history including prices paid and a keep versus return history (e.g., by price, style, brand, etc.) can be considered when providing a clothing recommendation.

As noted above, the extracted numeric data can be used to build a numeric estimation model that considers confidence weights associated with each input. For example, the “X” points representing image input data may be more numerous than other data points but may have a lower confidence weight as compared to reference object input data represented by “+” data points because the reference object may be of a known size. A greater confidence weight may be assigned to physical input data represented by “·” data points because they are more likely to be accurate and precise, as they include physical measurements of the particular child. Other example data points having particular confidence weights can include data points from image data with customer-provided clothing dimensions. Such input data may have a higher confidence weight, but fewer data points for instance, than other input data.

In some examples, a growth chart such as the growth chart 234 may include different amounts of data points. For instance, image input data such as that received at 222 may have the largest number of data points, as image data of the child may be readily available from a cloud storage service, user device storage, social media, etc. Other data points, such as those associated with physical input data received at 235, reference object input data received at 230, or customer-provided clothing dimensions, may be less numerous, as they are less often available.

Using the different data points, a body measurement estimation can be made by fitting different growth charts (e.g., a height chart, a weight chart, etc.) with a fit line based, for example, on a least root mean square error (or other approach), while assigning different confidence weights to different input data types. A calibrated or modified error, in some examples, can be determined based on a face value error and confidence weight, which can be based, in some examples, on customer feedback on particular fits of clothing.

Using the growth charts, a clothing recommendation can be provided. For instance, based on the growth charts, a predicted growth rate of the child can be determined, allowing for current and/or future predictions. For instance, a user can be presented (e.g., via an application of the user device) with a recommendation for clothing size or a particular article of clothing estimated to fit today, including whether the article of clothing may fit loosely (e.g., may last longer) or snugly (may last short period of time), among other fits (e.g., long, short, etc.). Similar, the user may be presented with a recommendation for clothing size or a particular article of clothing estimated to fit in a particular time period (e.g., 6 months), including how the article of clothing may fit.

In some examples, the numeric estimation model can be updated as new input data is received. For instance, the model building tool can use the data received, along with previously received data and additional data to self-learn sizes, measurements, preferences, brand nuances, and associated recommendations, for instance, as part of the machine learning model. The model building tool can identify (e.g., at a processing resource) output data representative of a clothing recommendation for the child, which may include a current size, future size, or particular clothing recommendation, or a combination thereof, among others.

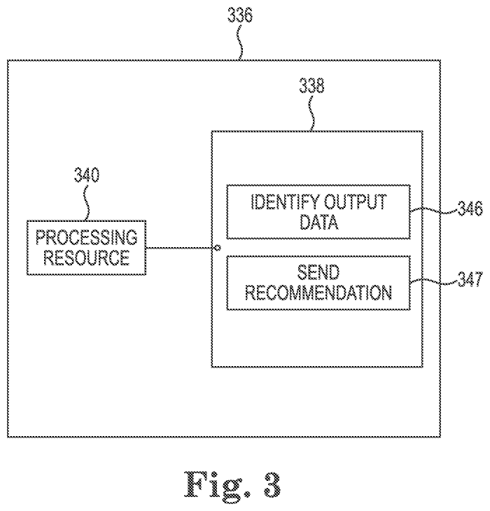

FIG. 3 is a functional diagram representing a processing resource 340 in communication with a memory resource 338 having instructions 346, 347 written thereon in accordance with a number of embodiments of the present disclosure. In some examples, the processing resource 340 and memory resource 338 comprise a system 336 such as a model building tool described with respect to FIGS. 1 and 2.

The system 336 illustrated in FIG. 3 can be a server or a computing device (among others) and can include the processing resource 340. The system 336 can further include the memory resource 338 (e.g., a non-transitory MRM), on which may be stored instructions, such as instructions 346, 347. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 338 may be electronic, magnetic, optical, or other physical storage device that stores executable instructions. Thus, the memory resource 338 may be, for example, non-volatile or volatile memory. For example, non-volatile memory can provide persistent data by retaining written data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory, resistive random access memory (RRAIVI), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random-access memory (SRAM), among others.

In some examples, the memory resource 338 is a non-transitory MRM comprising Random Access Memory (RAM), an Electrically-Erasable Programmable ROM (EEPROM), a storage drive, an optical disc, and the like. The memory resource 338 may be disposed within a controller and/or computing device. In this example, the executable instructions 346, 347 can be “installed” on the device. Additionally, and/or alternatively, the memory resource 338 can be a portable, external or remote storage medium, for example, that allows the system to download the instructions 346, 347 from the portable/external/remote storage medium. In this situation, the executable instructions may be part of an “installation package”. As described herein, the memory resource 338 can be encoded with executable instructions for making a clothing recommendation.

In some examples, the instructions, when executed by the processing resource 340 can cause the processing resource to receive, in association with a user request or data refresh or routine data refresh with prior user consent to receive, first input data including image data associated with an article of clothing associated with a child. The image data can include, for instance, image data from a user device (e.g., a camera roll of a tablet) or image data automatically received from a cloud storage service that includes the child wearing the article of clothing.

The user request, in some examples, can include user interaction with a retail website, retail application, or both. For instance, a user may access a retail website or retail application to access image data or look for children's clothing. The access can trigger the clothing recommendation process. The data refresh can include, in some examples, a routine data refresh that occurs with prior user consent to receive input data. In some instances, the data refresh occurs automatically with little or no user interaction other than prior granted consent.

The processing resource 340, in some examples can receive, in association with the user request, second input data including physical data associated with the child. The physical data, for instance, can include user uploaded growth information from the child's last physician visit, manual measurements of the child, or data sent from a health care provider source, among others.

In some instances, the processing resource 340, can receive, in association with the user request, third input data including image data of the child with a reference object. For instance, the image data can include a reference object of a known, or likely known, size in an image including the child. For instance, the child may be standing next to a refrigerator of an identifiable brand and model, such that measurements of the refrigerator may be accessible and comparable to the child in the image.

In some instances, the first, the second, and/or the third input data may be manually entered via an application of a user device for sending to the processing resource 340 or automatically (e.g., with little or no human intervention) to the processing resource 340. The first, the second, and/or the third input data may include timestamped metadata, for instance, such that a date of the input data is known (e.g., date photograph taken, date of physician examination, etc.).

In some examples, the first input data, the second input data, the third input data or any combination thereof is received from a user device in association with the user request. In other non-limiting examples, the first input data, the second input data, the third input data or any combination thereof is received from a cloud storage service. For instance, the user may request a recommendation from a retail website or application, which can trigger requests for input data (e.g., prompt a user to upload an image), or the input data may be continuously or near-continuously received, in some examples (e.g., automatically received from cloud storage service at particular time intervals).

In some instances, numeric data can be extracted from the first, the second, and the third input data. The numeric data can include measurements gleaned from the input data such as an estimated height, weight, arm length, leg length, neck circumference, etc. of the child. In some examples, the first, the second, and the third input data can each be assigned a confidence weight, and numeric data can be extracted from the weighted first, second, and third weighted input data. For instance, a higher confidence weight may indicate a more precise measurement (e.g., numeric data based on physician measurements), and a lower confidence weight may indicate a less precise measurement (e.g., numeric data based on a blurry photograph).

In some examples, a numeric estimation model based on the extracted numeric data can be built. In building the numeric estimation model, extracted numeric data from the different inputs can be considered independently and obtained to cross-calibrate and reduce estimation error within the numeric estimation model. For instance, numeric data from image input data, reference object input data, and physical input data may be different and may be associated with different confidence weights. These differences can be considered when building a numeric estimation model and providing a clothing recommendation.

In some examples, fourth input data may be received in associated with the user request that includes budget data. The budget data can include manually entered budget requests or data extracted from previous purchases, for example. The budget data can be used to refine, update, or both, clothing recommendations. In some instances, in response to the user request or the data refresh, a clothing size recommendation, a different article of clothing recommendation for the child based at least in part on the output data and the budget data, or both, to the user device.

Similar, in some examples, fifth input data may be received including calendar data. Calendar data can include, for instance, public calendar information such as public holidays or other observed holidays, seasonal data, and/or private calendar information such as upcoming events or travel. Numeric data can be extracted from the fifth input data, and the numeric estimation model can be built based on the extracted numeric data from the first, second, third, and fifth input data. Implementing the fourth input data, fifth input data, or both, together with the outputs of the numeric estimation model, can allow for recommendations within a desired budget and/or specific to upcoming events or seasons, in some examples.

The instructions 346, when executed by a processing resource such as the processing resource 340, can cause the processing resource to identify, using a model (e.g., the numeric estimation model) built based on input data previously received in association with an article of clothing associated with a child, physical data associated with the child, and image data of the child with a reference object, output data representative of a clothing size recommendation for the child, and the instructions 347, when executed by a processing resource such as the processing resource 340, can cause the processing resource to send, in response to the a request or a data refresh, the clothing size recommendation, a different article of clothing recommendation for the child based at least in part on the output data, or both, to a user device.

For instance, the user device may receive a clothing size recommendation of size X in brand A, but size Y in brand B. The recommendation may be for a hat, shoes, bracelet, pants, shirts, coats, etc., and may include recommendations for more than one article of clothing. The recommendation, in some examples, may recommend a different article of clothing (e.g., different than the article in the first input data) based on input received as preferences from the user such as materials, sizes, brands, colors, etc. In addition, the user may receive a recommendation based on particular fits of different brands and styles.

In a non-limiting example, the processing resource can transmit to the user device via signaling sent via a radio in communication with a processing resource of the user device, and the user can be prompted, via a user interface of the user device, to choose the output data representative of the recommendation or a particular recommendation if more than one is made. Responsive to the user's choice, the output data representative of the recommendation can be displayed via the user interface, and made available for purchase, for example. For instance, a user may choose and/or be provided with a recommendation for a winter coat that are estimated to fit a child immediately if it is a winter month but may opt for shorts that are estimated to fit the child well in six months. If the user's calendar indicates a trip to a tropical location, the recommendation (and/or purchase) may be for shorts that are estimated to fit immediately. More than one recommendation and more than one article of clothing may be presented to the user.

In some examples, the output data can be updated using an updated model previously updated; for instance, the numeric estimation model can be updated using a machine learning model and numeric data from additional input data (e.g., first input data, second input data, third input data, or any combination thereof). For instance, as new image input data, physical input data, and/or reference object input data is received, the numeric estimation model can be updated accordingly.

Other inputs may also be used to update the output data using an updated model previously updated, and/or to update the numeric estimation model and associated recommendations. Such inputs can include preference inputs, feedback received following purchases, returns of articles of clothing, calibrated sizes based on estimated sizes from image data including other children of known sizes, manufacturer dimensions, known clothing measurements from other children, budget data, previous purchase data, geographical location data, calendar data, or any combination thereof, among others.

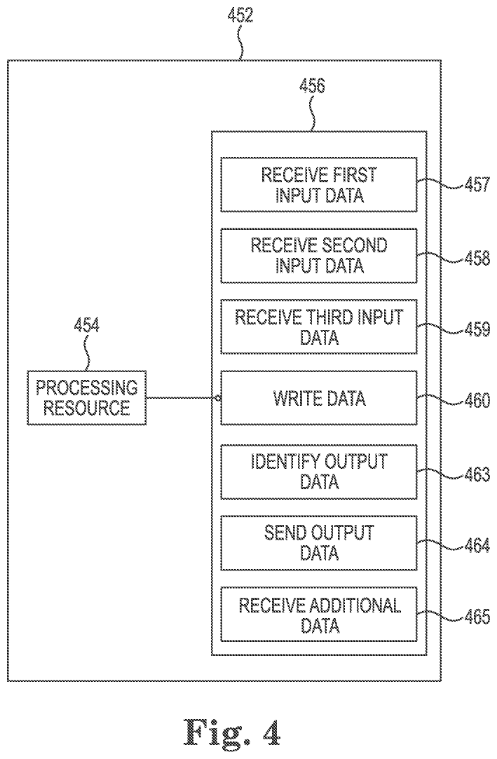

FIG. 4 is another functional diagram representing a processing resource 454 in communication with a memory resource 456 having instructions 457, 458, 459, 460, 463, 464, 465 written thereon in accordance with a number of embodiments of the present disclosure. In some examples, the processing resource 454 and the memory resource 456 may be analogous to processing resource 340 and memory resource 338, respectively, as described with respect to FIG. 3. In some examples, the processing resource 454 and the memory resource 456 comprise a system 452 such as a model building tool described with respect to FIGS. 1 and 2.

The instructions 457, when executed by a processing resource such as the processing resource 454, can cause the processing resource to receive at the first processing resource, the memory resource, or both, first input data including image data associated with an article of clothing associated with a child. Image data can include, for instance, photographs or other images received from a cloud storage service or a user (e.g., a camera roll, uploaded, etc.) that include the child wearing the article of clothing.

The instructions 458, when executed by a processing resource such as the processing resource 454, can cause the processing resource to receive at the first processing resource, the memory resource, or both, second input data different from the first input data including image data associated with the article of clothing. For instance, this second input data can include reference object data that include the child with a reference object of known or likely know dimensions.

The instructions 459, when executed by a processing resource such as the processing resource 454, can cause the processing resource to receive at the first processing resource, the memory resource, or both, third input data different from the first input data and the second input data from a plurality of sources, the plurality of sources comprising: image storage on a mobile device associated with the child, a portion of the memory resource or other storage, a health care provider database, a third-party retailer database, a calendar on the mobile device, environmental data, third-party websites, or any combination thereof. For instance, the third input data can include physical measurements, calendar data, seasonal data, preference data, clothing material, size, and/or style data, manufacturer specifications of articles of clothing, or any combination thereof, among others.

The instructions 460, when executed by a processing resource such as the first processing resource 454, can cause the processing resource to write the received first input data, the received second input data, and the received third input data to the memory resource 456. In some examples, the memory resource 456 or storage can be updated using the written data. The updated memory resource 456 or storage, along with updates to machine learning or AI can allow for self-learning and improved accuracy, efficiency, and consistency in making clothing recommendations.

In some examples, numeric data associated with the written data can be extracted and compared. For instance, measurements of the child can be estimated based on each of the different input types, and these estimations can be compared and used to build a numeric estimation model. For example, a numeric estimation model can be determined based on the extracted numeric data and the comparison. The comparisons can include considerations of confidence weights of the different input data types. For instance, measurements received from a physician's office may be more accurate and precise than those estimated using uploaded image data with no reference objects. These comparisons, including considerations of confidence weights, can be used to build projected, personalized growth charts and a numeric estimation model, which may or may not be a machine learning model, that can be used to estimate current and projected clothing sizes for the child.

The instructions 463, when executed by a processing resource such as the processing resource 454, can cause the processing resource to identify at the first processing resource or a second processing resource, using a numeric estimation model (e.g., the aforementioned determined numeric estimation model) built based on numeric data extracted from the written data, output data representative of a clothing size recommendation for the child, a different article of clothing recommendation for the child, or both based at least in part on the numeric estimation model. The recommendation can include estimated sizes in particular brands and/or styles, as well as particular articles of clothing (e.g., different than the article of clothing in the first input data) having product dimensions that match the estimated measurements of the child determined using the numeric estimation model.

In some examples, the output data can be updated using an updated model previously updated using fourth input data including budget data, and a recommendation can be updated, refined, or both based on the budget data. This can be manually entered by a user or determined based on past purchases. For instance, a user may tend to spend ten dollars or less on shirts, so this can be included as budget data and used to improve recommendations. In such examples, output data associated with the different article of clothing can be identified such that a recommendation can be made that corresponds to the budget data.

Similar, in some instances, fifth input data including third party data associated with an article of clothing associated with a different child can be received. For instance, the fifth input data can be used as calibration data. In a non-limiting example, data associated with a different child or different children and having known measurements can be received and used to calibrate and improve the numeric estimation model. For instance, a user may opt to allow their child's physical measurements to be used to improve recommendations for other children. In some examples, the user may be compensated for participation. Numeric data can be extracted from the fifth input data, and the numeric data can be build based on the extracted first, second, third, and fifth input data and a comparison thereof. For instance, if data associated with a different child indicates a particular article of clothing runs small, this data can be used to improve a clothing recommendation for others.

The instructions 464, when executed by a processing resource such as the first processing resource 454, can include instructions to send the output data to a user device. The user can receive the recommendation, and he or she may be allowed to purchase items, for instance, via a retail website or application.

The instructions 465, when executed by a processing resource such as the first processing resource 454, can cause the processing resource to receive additional first input data, second input data, third input, or any combination thereof to update the numeric estimation model using a first machine learning model. A request may be received to update the numeric estimation model, in some examples. For instance, the numeric estimation model may be updated in response to a user request to interact with a retail website, application, or both, including a purchase of the different article of clothing or another article of clothing. For instance, a purchase may result in similar recommendations in the future. The numeric estimation model may be updated, in some instances, in response to a user request to interact with a retail website, application, or both, including a return of the different article of clothing or another article of clothing. For instance, a return may result in different recommendations in the future, as well as adjustments to the numeric estimation model if a poor fit is indicated.

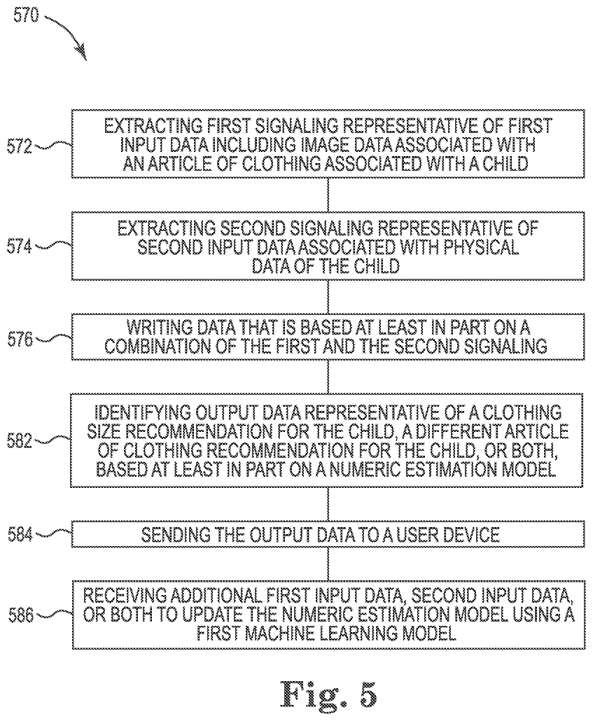

FIG. 5 is yet another flow diagram representing an example method 570 for making a clothing recommendation in accordance with a number of embodiments of the present disclosure. The method 570 can be performed by a system such as the systems 336 and 452 described with respect to FIGS. 3 and 4, respectively.

At 572, the method 570 can include extracting, by a first processing resource from a memory resource of a user device, first signaling representative of first input data including image data associated with an article of clothing associated with a child, wherein the first input data has a first confidence weight. The image data, for instance, can include image data received from a cloud storage service or a user device. The confidence weight, for instance, can indicate a confidence in the accuracy and/or precision of the input data. A higher confidence weight may indicate a greater confidence in the input data and numeric data extracted therefrom.

The method 570, at 574, can include extracting, by the first processing resource from the memory resource, second signaling representative of second input data associated with the physical data of the child, wherein the second input data has a second confidence weight higher than the first confidence weight. For example, measurements taken by a physician or nurse during an annual examination may be more precise than image data received from a cloud storage service and associated extracted numeric data.

At 576, the method 570 can include writing from the first processing resource to the memory resource, data that is based at least in part on a combination of the first and the second signaling. The data can be stored, for instance at the memory resource for future use and updating of associated models (e.g., numeric estimation models, machine learning models, etc.).

In some examples, the method 570 can include extracting, by the first processing resource, third signaling representative of third input data including image data of the child with a reference object. The reference object, for instance, may be of a known or likely known size with known or likely known dimensions that allow for comparison to the child's size. The third input data can have a third confidence weight and the data written from the first processing resource to the memory resource can include data that is based at least in part on a combination of the first, the second, and the third signaling.

In some examples, the method 570 can include receiving, at the first processing resource, fourth signaling representative of fourth input data including past weather information, current weather information, future weather information, or any combination thereof, associated with a physical location of the child. The fourth input data may have a fourth confidence weight. Data written from the first processing resource to the memory resource can be based at least in part on a combination of the first, the second, and the fourth signaling.

In some examples, the method 570 can include extracting numeric data from the data written from the first processing resource. The numeric data can include estimated physical measurements of the child. These can include the actual measurements, for instance taken by a physician, or estimated measurements based on the image data and/or other input data.

In some instances, the method 570 can include determining a numeric estimation model based on the extracted numeric data and the first and the second confidence weights. For instance, the numeric estimation model can create a projection of growth for the child, for instance using a least root mean square error model or other estimation model. The projection, for instance can stay nearer points having higher confidence weights, but the projection may stray from points with lower confidence weights. In a non-limiting example, the numeric estimation model indicates a child's height increasing faster as compared to his or her weight. This pattern may be considered when making a recommendation for pants desired in six months, for instance. In some examples, the numeric estimation model is a machine learning model based on the extracted numeric data and the first and the second confidence weights. The machine learning model can self-learn and update as additional inputs are received.

The method 570, at 582, can include identifying, at the first processing resource or a second, different processing resource, output data representative of a clothing size recommendation for the child, a different article of clothing recommendation for the child, or both, based at least in part on a numeric estimation model (e.g., the aforementioned determined numeric estimation model) built based on numeric data extracted from the data written from the first processing resource and the first and the second confidence weights. For instance, the recommendation can include a future clothing size recommendation for the child, a future different article of clothing recommendation for the child, or both, based at least in part on the numeric estimation model. In some examples, the recommendation can include a future clothing size recommendation for the child for a particular event, a future different article of clothing recommendation for the child for the particular event, or both, based at least in part on the numeric estimation model and calendar data received from a processing resource of the user device or a memory resource of the user device.

At 584, the method 570 can include sending the output data to a user device. For instance, the output data can be sent via a radio in communication with a processing resource of a computing device accessible by the user. For example, the user can receive clothing recommendation and directions to purchase clothing via an application on a user device. A radio can include, but is not limited to, wireless or wired communication methods.

At 586, the method 570 can include receiving additional first input data, second input data, or both to update the numeric estimation model using a first machine learning model. For instance, the numeric estimation model and the first machine learning model may begin using generic input data that includes basic sizes and measurements of children's clothing without specificity to a particular child. As more input data is included and purchases made, the first machine learning model can continuously update and improve accuracy of the numeric estimation model, and in turn, clothing recommendations.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium storing instructions, the instructions when executed by a processing resource cause the processing resource to:
identify, using a model built based on input data previously received in association with an article of clothing associated with a child, physical data associated with the child, and image data of the child with a reference object, output data representative of a clothing size recommendation for the child; and
send, in response to a user request or a data refresh, the clothing size recommendation, a different article of clothing recommendation for the child based at least in part on the output data, or both, to a user device.

2. The medium of claim 1, wherein the user request comprises user interaction with a retail website, retail application, or both.

3. The medium of claim 1, further comprising the processing resource to update the output data using an updated model previously updated using a machine learning model and numeric data from additional input data.

4. The medium of claim 1, further comprising the processing resource to:
update the output data using an updated model previously updated using additional input data including budget data; and
send the clothing size recommendation, a different article of clothing recommendation for the child based at least in part on the updated output data and the budget data, or both, to the user device.

5. The medium of claim 1, wherein the processing resource to identify the output data using the model built based on input data previously received comprises the processing resource to use the model built based on input data having different weights assigned to different types of the input data.

6. The medium of claim 1, further comprising the processing resource to identify the output data using the model built based on input received from the user device in association with the user request or data refresh.

7. The medium of claim 1, further comprising the processing resource to identify the output data using the model build based on input received from a cloud storage service.

8. The medium of claim 1, further comprising the processing resource to:
update the output data using an updated model previously updated using fifth input data including calendar data.

9. A method, comprising:
extracting, by a first processing resource from a memory resource of a user device, first signaling representative of first input data including image data associated with an article of clothing associated with a child,
wherein the first input data has a first confidence weight;
extracting, by the first processing resource from the memory resource, second signaling representative of second input data associated with the physical data of the child,
wherein the second input data has a second confidence weight higher than the first confidence weight;
writing from the first processing resource to the memory resource, data that is based at least in part on a combination of the first and the second signaling;
identifying, at the first processing resource or a second, different processing resource, output data representative of a clothing size recommendation for the child, a different article of clothing recommendation for the child, or both, based at least in part on a numeric estimation model built based on numeric data extracted from the data written from the first processing resource and the first and the second confidence weights;
sending the output data to a user device; and
receiving additional first input data, second input data, or both, to update the numeric estimation model using a first machine learning model.

10. The method of claim 9, further comprising identifying the output data based at least in part on the numeric estimation model, wherein the numeric estimation model is built using a second machine learning model that uses the extracted numeric data and the first and the second confidence weights.

11. The method of claim 9, further comprising:
extracting, by the first processing resource, third signaling representative of third input data including image data of the child with a reference object,
wherein the third input data has a third confidence weight; and
writing from the first processing resource to the memory resource coupled to the first processing resource, data that is based at least in part on a combination of the first, the second, and the third signaling.

12. The method of claim 9, further comprising:
receiving, at the first processing resource, fourth signaling representative of fourth input data including past weather information, current weather information, future weather information, or any combination thereof, associated with a physical location of the child,
wherein the fourth input data has a fourth confidence weight; and
writing from the first processing resource to the memory resource coupled to the first processing resource data that is based at least in part on a combination of the first, the second, and the fourth signaling.

13. The method of claim 9, further comprising identifying, at the first processing resource or a second, different processing resource, output data representative of a future clothing size recommendation for the child, a future different article of clothing recommendation for the child, or both, based at least in part on the numeric estimation model.

14. The method of claim 9, further comprising identifying, at the first processing resource or a second, different processing resource, output data representative of a future clothing size recommendation for the child for a particular event, a future different article of clothing recommendation for the child for the particular event, or both, based at least in part on the numeric estimation model and calendar data received from a processing resource of the user device or a memory resource of the user device.

15. A non-transitory machine-readable medium storing instructions, the instructions when executed by a first processing resource cause the first processing resource to:
receive at the first processing resource, the memory resource, or both, first input data including image data associated with an article of clothing associated with a child;
receive at the first processing resource, the memory resource, or both, second input data different from the first input data including image data associated with the article of clothing;
receive at the first processing resource, the memory resource, or both, third input data different from the first input data and the second input data from a plurality of sources, the plurality of sources comprising: image storage on a user device associated with the child, a portion of the memory resource or other storage, a health care provider database, a third-party retailer database, a calendar on the user device, environmental data, third-party websites, or any combination thereof;
write the received first input data, the received second input data, and the received third input data to the memory resource;
identify at the first processing resource or a second processing resource, using a numeric estimation model built based on numeric data extracted from the written data, output data representative of a clothing size recommendation for the child, a different article of clothing recommendation for the child, or both;
send the output data to a user device; and
receive additional first input data, second input data, third input, or any combination thereof to update the numeric estimation model using a first machine learning model..

16. The medium of claim 15, wherein the numeric estimation model comprises a second machine learning model.

17. The medium of claim 15, further comprising the first processing resource to receive a request to update the numeric estimation model in response to a user request to interact with a retail website, application, or both, including a purchase of the different article of clothing or another article of clothing.

18. The medium of claim 15, further comprising the first processing resource to:
receive fourth input data including budget data; and
identify at the first processing resource or the second processing resource output data representative of the recommendation for the different article of clothing,
wherein the recommendation for the different article of clothing corresponds to the budget data.

19. The medium of claim 15, further comprising the first processing resource to receive a request to update the numeric estimation model in response to a user request to interact with a retail website, application, or both, including a return of the different article of clothing or another article of clothing.

20. The medium of claim 15, further comprising the first processing resource to:
receive fifth input data including third party data associated with an article of clothing associated with a different child,
wherein the numeric estimation model is built based on numeric data extracted from the written data including the fifth input data.
